(19) United States
(12) Patent Application Publication
(10) Pub. No.: US 2022/0321734 A1
(43) Pub. Date: Oct. 6, 2022

(54) DETERMINING HALF-TONING PARAMETERS

(71) Applicant: HEWLETT-PACKARD DEVELOPMENT COMPANY, L.P., Spring, TX (US)

(72) Inventors: Jordi Sender Beleta, Sant Cugat del Valles (ES); Utpal Kumar Sarkar, Sant Cugat del Valles (ES); Maria Isabel Borrell Bayona, Sant Cugat del Valles (ES); Andres Fonts Santana, Sant Cugat del Valles (ES)

(73) Assignee: HEWLETT-PACKARD DEVELOPMENT COMPANY, L.P., Spring, TX (US)

(21) Appl. No.: 17/616,009

(22) PCT Filed: Jul. 31, 2019
(86) PCT No.: PCT/US2019/044406

§ 371 Date: Dec. 2, 2021

(51) Int. Cl. H04N 1/405; G06F 3/12

(52) U.S. Cl. CPC H04N 1/405; G06F 3/1208; G06F 3/121; G06F 3/1254; G06F 3/1257

(57) ABSTRACT

An image processing method is disclosed. The method includes receiving information relating to a print component to be used to print a target image; determining, based on the received information relating to the print component, half-toning parameters to be applied when generating a half-tone representation of the target image; and generating, using the determined half-toning parameters, a half-tone representation of the target image. An apparatus and a machine-readable medium are also disclosed.

### BACKGROUND

A print apparatus may be used to print a target image onto a printable substrate during a printing operation. Prior to performing the printing operation, a half-tone representation of the target image may be prepared, which defines where drops of print fluid (e.g. ink) are to be deposited in order to achieve a printed image resembling the target image.

In some examples, various factors relating to components of the print apparatus, such as manufacturing intolerances, may result in print quality defects in the resulting printed image.

### BRIEF DESCRIPTION OF DRAWINGS

Examples will now be described, by way of non-limiting example, with reference to the accompanying drawings, in which:

FIG. 1 is a flowchart of an example of an image processing method,

FIG. 2 is a flowchart of a further example of an image processing method;

FIG. 3 is a schematic illustration of an example of an apparatus for generating a half-tone representation;

FIG. 4 is a schematic illustration of a further example of an apparatus for generating a half-tone representation; and

FIG. 5 is a schematic illustration of a processor in communication with a shine-readable medium,

### DETAILED DESCRIPTION

When performing printing operations, print quality defects in the resulting printed image may occur for various reasons. In some examples, a print component within the print apparatus may be responsible for defects appearing in the resulting printed image. Such defects may occur as a result of manufacturing intolerances in the components, or simply aerodynamic effects that affect ink as it is being deposited onto a printable substrate from a print component. Replacing, repairing War adjusting the print components of themselves in order to mitigate or remove the print quality defects altogether can be costly and time-consuming. According to the present disclosure, a mechanism is provided whereby the half-tone representation of the target image may be generated based on the print components that are to be used to print the target image. Briefly. with knowledge of the print components that are to be used to print the target image, print quality defects that are likely to occur can be determined, and an appropriate half-toning operation can be performed to take account of the potential defect. In other words, some regions of the half-tone representation of the target image may be generated differently from other regions of the half-tone representation, based on print components, or part of the print components, to be used to print the corresponding regions in the printed image.

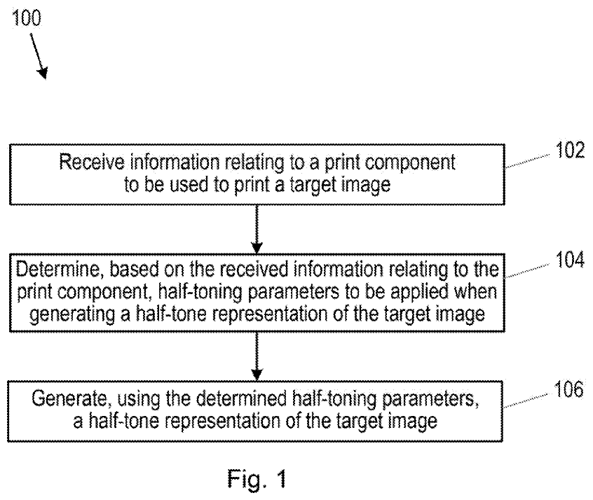

Referring to the drawings, FIG. 1 is a flowchart of an example of a method 100, which may be considered to be an image processing method. The method 100 comprises, at block 102, receiving information relating to a print component to be used to print a target image. Printing the target image results in a printed version of the target image. The information relating to a print component may, for example, comprise an indication of the print component or the type of print component to be used. Based on a knowledge of the identity of the print component, the method may, in some examples, comprise accessing a database or a lookup table to obtain information regarding a print quality defects that may occur during a printing process resulting from the print component (or a part thereof). In other examples, the method may comprise accessing a database or a lookup table to obtain information regarding half-toning parameters that are to be used when preparing a half-tone representation of the target image in respect of the portion of the image to be printed using the print component. In other words, a database or a lookup table may store information relating just to the nature (e.g. type and/or location) of the print defect that is likely to/has the potential to occur, such that a determination may be made as to the appropriate half-toning parameters be used to mitigate or prevent the defect from occurring, or the database or lookup table may store information relating to the particular half-toning parameters that are appropriate to mitigate or prevent a defect from occurring, in view of the print component. While the method discussed herein refers to just one print component, it will be understood that a print apparatus may include multiple print components, and the method may include receiving and using information relating to a number of print components.

At block 104, the method 100 comprises determining, based on the received information relating to the print component, half-toning parameters to be applied when generating a half-tone representation of the target image. Thus, as discussed in greater detail below, with knowledge of a print component, or part of a print component, to be used in the printing operation, the method 100 is able to determine how the half-toning of the target image is to be performed (i.e, how the half-tone representation is to be generated in respect of those parts of the target image that are to be printed using the identified print component(s) or part(s) thereof). As noted above, half-toning parameters associated with particular print components or parts thereof may be stored in a database or a lookup table and, in such examples, determining the half-tone parameters to be applied may comprise accessing the database or lookup table to retrieve the half-toning parameters associated with the identified print component

The method 100 comprises, at block 106, generating, using the determined half-toning parameters, a half-tone representation of the target image. As noted above, the half-tone representation of the target image is a representation (e.g. a digital representation) showing how drops of print fluid (e.g. black ink and/or ink of different colours, such as cyan, magenta and yellow) are to be deposited onto a printable substrate in order to print the target image. The half-tone representation may include an indication of a size (e.g. a diameter or volume), a position and/or a colour of each drop of print fluid that is to be deposited. In other examples, the half-tone representation may include values or references indicative of an amount of print fluid to be deposited at each position on the printable substrate. Various techniques may be used for preparing a half-tone representation of an image to be printed and different half-toning parameters may be relevant for each half-toning technique. In some existing print apparatuses, a single half-toning technique may be used for generating a half-tone representation for an entire image. However, according to the present disclosure, the half-toning technique(s), and therefore the half-toning parameters, to be applied when generating the half-tone representation are determined based on the print component to be used during a printing operation.

Blocks of method 100 may be performed using a processor or processing apparatus, for example a processor of a computing device or a processor associated with or incorporated into a print apparatus.

By determining half-toning parameters be applied based on the print component to be used, it is possible to take account of any predicted print, quality defects that may result from the use of the print component. Therefore, print quality may be improved the resulting print product. As a consequence of improving the print quality, less time may be spent taking action to correct for quality defects, such as replacing defective print components.

A print apparatus typically includes a print head, or multiple print heads, from which fluid, such as ink, is deposited onto a printable medium or substrate (e.g. paper or cardboard) during the printing operation. Some print apparatuses include multiple print heads formed or mounted on a structure sometimes referred to as a print bar. For example, in a page wide array (PWA) print apparatus, a print bar may include 8 print heads. Each print head in a print apparatus may include a die or multiple dies, and each die may include a plurality of nozzles through which print fluid is selectively deposited. The number of nozzles per unit of length (e.g. inch or centimetre), which may be referred to as the nozzle density, may correspond to the print resolution achievable by the print apparatus; for example, a print apparatus capable of printing at 1200 dots per inch (DPI) may have 1200 nozzles per inch (e.g. per inch length or per square inch) arranged or formed in its die or dies. In some print apparatuses, such as a page wide array print apparatus, a single print bar may remain stationary relative to other parts of the print apparatus during a printing operation, and a printable medium or substrate may be moved under the print bar while print fluid is deposited from nozzles in'the print. In other print apparatus, a print head may be mounted in a carriage which can perform a number of printing passes over the printable medium while depositing print fluid during a printing operation. Print components e.g. the print heads, the nozzles and/or the print bars) in various print apparatuses may have particular characteristics that give rise to particular print quality defects in a resulting printed image.

Various scenarios where print components or parts of print components may cause print quality defects to occur are discussed below.

In some print apparatuses, characteristics of print fluid/drops deposited from nozzles at or near to the edges or boundaries of a die may be different from characteristics of drops deposited from nozzles at or near to the centre of the die (or away from the edges or boundaries of the die). Aerodynamic effects and/or thermal effects may cause print fluid deposited from different nozzles in the die to behave differently. Thermal effects may cause a change in drop volume which, in turn, may cause drop size and/or drop shape to change when print fluid is deposited onto a printable medium. A decrease in temperature may cause less print fluid to be deposited, while an increase in temperature may cause more ink to be deposited. Aerodynamic effects may affect how drops of print fluid ejected from nozzles land on a printable medium. In some examples, print fluid may remain at a nozzle platen, forming what is referred to as a puddle, which may cause subsequent drops to be ejected in a different trajectory from the nozzle. Examples of other adverse print fluid behaviour includes irregular (e.g. non-circular) drop shapes, drop position displacement, optical density variations and print fluid discolouration resulting from a chemical change in the print fluid).

In large format printers, a print head may include a plurality of partially overlapping dies. In the region in which the dies overlap (sometimes referred to as a weaving zone or stitching zone), the print head may include twice as many nozzles to print the same part of the image on the printable medium. In some examples, the overlapping dies, or the nozzles thereof, may not be perfectly aligned with one another and, therefore, a print quality defect may result in the form of a non-uniform strip, sometimes referred to as “banding”. The term “banding” may also be used to refer to any change in optical density in a printed image.

Some print apparatuses may include components capable of monitoring nozzles in the print heads to determine if a nozzle becomes blocked or stops functioning as intended, if it is determined that a particular nozzle or group of nozzles is not functioning as intended (e.g. if the nozzles are not depositing print fluid in the intended manner), then half-toning parameters may, be determined accordingly, to compensate for the defective nozzles.

In scanning print apparatuses, in which, a print head is to deposit print fluid as it scans bi-directionally across a printable medium (e.g. moving from side to side across the substrate as it prints), a print quality defect (e.g. a difference in hue) may occur in regions of the image where the print head prints first from left to right and then from right to left. This may happen when an order in which print fluid is deposited changes between passes of the print head; for example, during a first (left-to-right) pass, black print fluid may be deposited on top of magenta print fluid, while, during a second (right-to-left) pass, magenta print fluid may be deposited on top of black print fluid.

High resolution print heads (e.g. print heads capable of printing at a high DPI) have a large number of nozzles per unit length formed on its dies. In order to enable the appropriate number of dies to be included in the print head, along with the appropriate circuitry, nozzles are, in some scenarios (e.g. in page wide array print apparatuses), arranged in multiple columns which are slightly offset from one another in the direction in which the substrate advances as it is printed. The offset nozzles are fired with a slight delay such that, as the substrate advances, print fluid deposited from the two columns of nozzles at an intended position on the printable medium. However, nozzles in different columns may have different characteristics, leading to print quality defects in the printed image. For example, manufacturing differences or defects in the dies in the print head may cause print fluid to be deposited at different angles relative to the vertical, thereby causing print fluid from some dies to the deposited in the offset location relative to print fluid deposited by other dies,

It will be apparent from the above discussion that different parts of particular components may lead to different print quality defects in a printed image, and that these different defects may be compensated for differently using appropriate half-toning techniques. In other words, particular half-toning parameters may be determined to compensate for defects resulting from one part of a print component, while other, different half-toning parameters may be determined to compensate for defects resulting from another part of the print component, or from another component altogether. Thus, a single half-tone representation generated at block 106 may be generated using multiple half-toning techniques, or by using multiple different half-toning parameters. Thus, in some examples, different half-toning parameters may be used for generating different regions of the half-tone representation.

In some examples, the half-tone representation may be considered to be segmented into a plurality of regions, and each region in the half-tone representation may be generated using a different half-tone parameter or set of half-tone parameters. For example, a first half-toning technique (e.g. using a first set of half-toning parameters) may be applied to those parts of the target image where no print quality defects are expected to occur as a result of the print components used in the printing operation. A second half-toning technique (e.g. using a second set of half-toning parameters) may be applied to those parts of the target image where a print defect may be expected to occur as a result of a particular part of a print component (e.g, in a region of an image where banding may be expected due to being printed by nozzles at the edge of a die). A third half-toning technique (e.g. using a third set of half-toning parameters) may be applied to those parts of the target image where another, print defect may be expected to occur as a result of another part of a print component (e.g. in a region of the image where a defect may be expected due to partially overlapping dies in the print head). Thus, in this example, three different half-toning parameters (or sets of parameters) may be generated to take account of print defects expected to occur in three different regions of the printed image, based on knowledge of the print components that are to be used to print the image in those regions.

More generally, determining the half-toning parameters (block 102), in some examples, comprise determining a first set of half-toning parameters in respect of a first region of the half-tone representation and determining a second set of half-toning parameters in respect of a second region of the half-tone representation.

Various half-toning techniques may be employed when generating a half-tone image of a target image to be printed. Certain half-toning techniques may be more appropriate than others at different regions of the image, depending on the nature of the print quality defect expected to occur. Thus, the half-toning parameters or half-toning technique determined for each region of the half-tone representation are based on the print 1 g component that will be used to print the corresponding region of the target image.

In some examples, half-toning parameters may be determined according to a first half-toning technique, known as search-based half-toning. In the search-based half-toning technique, an objective function that varies from region to region is optimised. By modelling the placement of the print fluid drops over the print substrate, changes can be made to the objective function in those regions corresponding to print quality defects in order to improve the print quality and increase the score of the objective function.

In another example, half-toning parameters may be determined according to a second half-toning technique, known as matrix half-toning. Matrix half-toning, sometimes referred to as screen-based half-toning or dithering, involves, for each pixel of the target image, setting a single threshold value for a particular colour based on a greyscale value. For example, if at a given pixel of the target image, the threshold value is 77 and the greyscale value is between 0 and 76, then no print fluid is to be deposited by a nozzle in a corresponding location onto the printable medium, and if the greyscale value is between 77 and 255, then a drop of print fluid is to be deposited by a nozzle in a corresponding location onto the printable medium. For regions in an image where regular (e.g. consistent) print quality defects are expected to occur, such as in regions printed by nozzles located at die boundaries, then the matrix may be modified accordingly. For example, in regions corresponding to overlapping dies, a change in optical density or graining may be caused in the printed image. Thus, the half-tone matrix in corresponding regions may be modified to be more robust to such changes and/or to compensate for such an expected change in that region. Similarly, if it is determined that a particular nozzle or group of nozzles in a die is defective, then characteristics of the matrix may be modified to reduce the number of drops in regions corresponding to the defective nozzles. In some examples, in regions where a print quality defect may be expected, the threshold value (i.e. between 0 and 265) may be varied or even randomly selected for cells in the matrix corresponding to the region in which the print quality is expected. In this way, a defect that may otherwise be particularly, clear and visible in a printed image may be disguised or blended in and, therefore, less visible.

In another example, half-toning parameters may be determined according' to a third half-toning technique, known as error diffusion. In error diffusion, the error caused by thresholding a particular pixel is calculated and propagated to neighbouring pixels or locations in specific proportions (e.g. weights). For example, in some regions of an image, the error may be diffused evenly among unprocessed neighbour locations while, in other regions, the error may be diffuse randomly. In some examples, the decision regarding whether or not print fluid is to be deposited at a particular position may be made in a position-dependent manner. As such, detailed changes to the half-tone representation may be made to correct for very specific print quality defects likely to occur in the, printed image.

Thus, in some examples, the determining of half-toning parameters (block 104) may comprise applying a half-toning technique selected from a group comprising:

search-based half-toning; matrix half-toning; and error diffusion.

Half-toning parameters may be determined according to various other half-toning techniques, which may be implemented according to various examples of the present disclosure, in combination with any of the techniques described above, or separately. In other examples, other half-toning techniques not discussed above may be used. For example, a half-toning technique may be implemented in which, for each location in a half-tone representation, an intended combination of print fluid of different colours is defined. In some examples, techniques may be used to de-correlate different colours used in the target image, in order to reduce the visible effects of colour-to-colour misregistration. In other examples, noise may be introduced into the half-tone representation of the target image in order to reduce the severity of a print quality defect. Examples include “green noise” (sometimes referred to as clustered dot half-toning), which shows robustness to drop placement errors, “blue noise” (sometimes referred to as dispersed dot half-toning), and “white noise”.

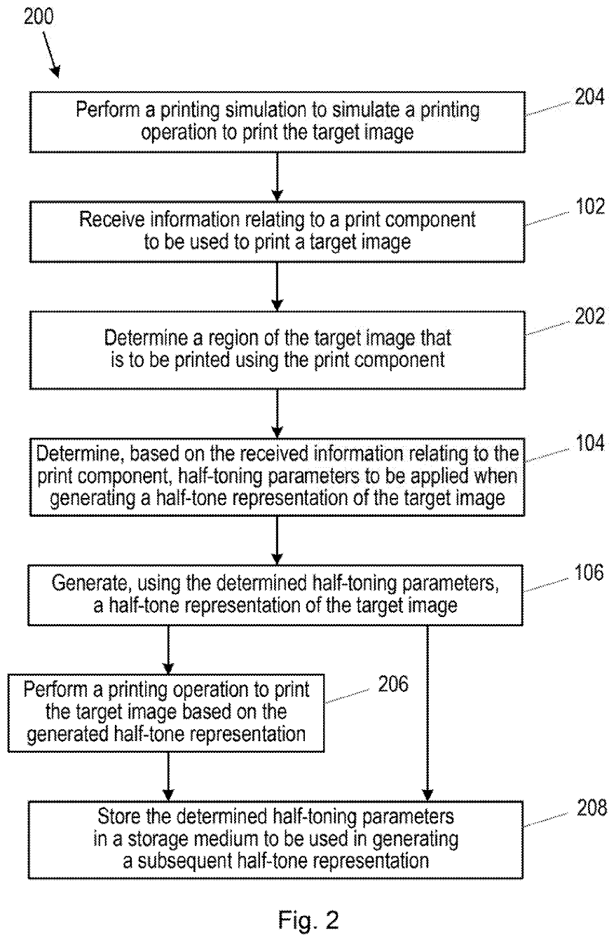

Referring again to the drawings, FIG. 2 is a flowchart of a further example of a method 200, such as an image processing method. The method 200 may include blocks of the method 100. The method 200 may comprise, at block 202, determining a region of the target image that is to be printed using the print component. Particular regions in a printed image may be printed using a particular part of a print component (e.g. nozzles at an age of a die) and, at block 202, those regions may be identified. The determining of half-toning parameters to be applied (block 104) may comprise determining half-toning parameters to be applied in the determined region of the target image. In some cases, a print component or multiple print components may be expected to cause print quality defects in multiple regions in a printed image and, in such examples, half-toning parameters may be determined which are to be applied in different regions of the half-ton representation.

As noted above, in some examples, knowledge of possible print quality defects associated with a particular print component may be readily available; for example, information relating to the print components may be stored in a database and, in some examples, half-toning parameters to be applied when generating a half-tone representation of a target image may also be stored in and retrievable from a database. in other examples, however, half-toning parameters may be determined using a computer simulation of a printing operation, for example, prior to the printing operation. Thus, in some examples, the method 200 may comprise, at block 204, performing a printing simulation to simulate a printing operation to print the target image. The receiving of information (block 102) may comprise obtaining information based on the printing simulation. In some examples, performing the printing simulation (block 204) may comprise executing a computer-implemented printing model. In some examples, a printing simulation may be performed using a virtual printer, capable of simulating a printing operation using software. The simulation attempts to model physical properties of the print apparatus, including the print components expected to cause print quality defects.

Printing simulations may be performed quicker than a full printing operation, and fewer resources (e.g. print mediums and print fluid) are used when performing a printing simulation compared to printing the image using the print apparatus.

A printing simulation is capable of demonstrating print quality defects that are likely to occur in a printed image given parameters of the print components of the print apparatus that are to be used to print the image.

At block 206, the method 200 may further comprise performing a printing operation to print the target image based on the generated half-tone representation, Thus, once the half-tone representation has been generated using the determined half-tone parameters, the target image may be printed using a print apparatus which includes the print components. In some examples, a processor used to perform the blocks of the methods 100, 200 discussed herein may form part of a print apparatus used to carry out the printing operation. In other examples, the half-tone representation transmitted to a print apparatus (or to a processor of a print apparatus) by the processor used to perform the methods 100, 200.

In some examples, the method 200 may comprise, at block 208, storing the determined half-toning parameters in a storage medium to be used in generating a subsequent half-tone representation. Thus, once suitable half toning parameters have been determined (at block 104), the parameters may be stored so that they can be obtained at a later date. For example, the half-toning parameters may be stored in a database accessible by a processor. In some examples, the half-toning parameters may be stored (at block 208) without performing the printing operation (at block 206 while, in other examples, the method 200 may include both printing (block 206) and storing (block 208).

As noted above, blocks of the methods 100, 200 may be performed using a processor or processing circuitry forming part of a computing device (e.g. a desktop computer, a laptop computer, a tablet computer, a smart phone, a server or a wearable device) or forming part of a print apparatus, such as the print apparatus used to print the target image.

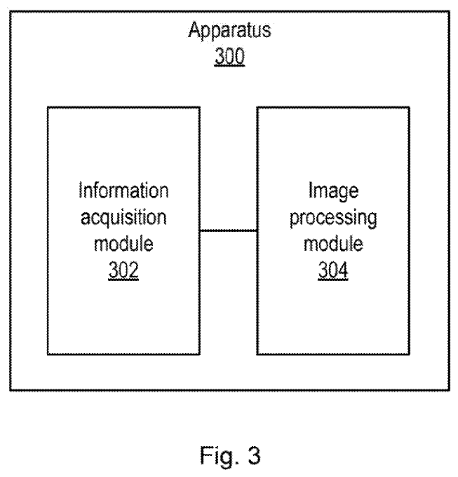

FIG. 3 is a schematic illustration of an example of apparatus 300 that may be used to perform blocks of the methods 100, 200. The apparatus 300 comprises an information acquisition module 302 and an image processing module 304 The information acquisition module 302 is to obtain information relating to a print component to be used to print an image. For example, the information acquisition module 302 may perform the receiving of block 102. The image processing module 304 is to generate a half-tone representation of the image using a set of parameters selected based on the obtained information. In some examples, the image processing module 302 may be considered to perform the determining and generating of blocks 104 and 106.

In some examples, the image processing module 304 may determine a region of the image to be printed using the print component, The image processing module 304 may generate a first portion of the half-tone representation of the image using a first set of parameters based on the obtained information. The image processing module 304 may generate a second portion of the half-tone representation of the image using a second set of parameters. For example, the first set of parameters may be selected in order to take account of a possible print quality defect that is likely to arise as a result of the print component being used. These may differ from the second set of parameters, which may be selected based on a different half-toning technique, which may not take account of any expected defects.

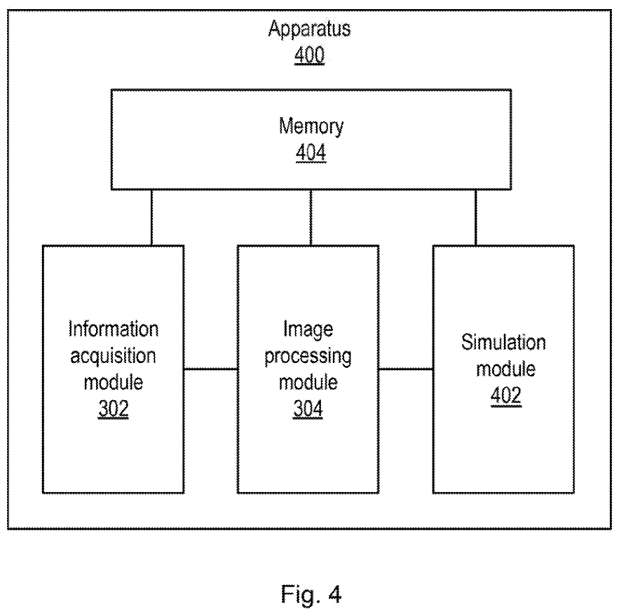

FIG. 4 is a schematic illustration of a further example of an apparatus 400. The apparatus 400 may include blocks shown in the apparatus 300. in some examples, the apparatus 400 includes the information acquisition module 302 and the image processing module 304. The apparatus 400 may further comprise a simulation module 402. The simulation model 402 may execute a computer-implemented model of a printing operation to print the image using the print component, in this way, the print operation may be run in a virtual manner (e.g, using a so-called virtual printer) prior to printing the target image onto a printable substrate, so that appropriate half-toning parameters can be determined in view of the print apparatus and the print component(s) to be used. While, in some examples, the computer-implemented model of the printing operation may be executed or run using a processor forming part of the apparatus 300, 400, in other examples, the simulation module 402 may execute the computer-implemented model using a processor remote from the apparatus itself. The results of executing the model may be accessed by or delivered to the simulation module 402. The information acquisition module 302 is to obtain the information relating to the print component based on an output of the computer-implemented model. For example, the results of the executed model may reveal that a particular component is prone to causing a particular print quality defect at a certain position on a printed image, and this information, may be obtained by the information acquisition module 302.

The apparatus 400 may, in some examples, comprise a memory 404, accessible by the information acquisition module 302, to store information relating to the print component. Thus, the information acquisition module 302 may obtain information relating to the print component from the memory 404. The memory 404 may store details of half-toning parameters associated with print components, so that, instead of executing a computer-implemented model, half-toning parameters may, in some examples, be obtained from the memory 404.

The modules 302, 304, 402, 404 may be implemented using a processor (not shown in FIG. 4) forming part of the apparatus or remote from, but in communication with the apparatus.

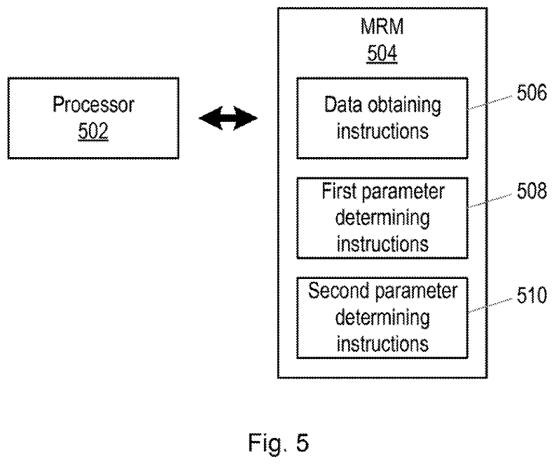

Examples disclosed herein may also be implemented using a machine-readable medium and a processor. FIG. 5 is a schematic illustration of an example of a processor 502 in communication with a machine-readable medium 504. The machine-readable medium 504 comprises instructions which, when executed by a processor (e.g. the processor 502), cause the processor to perform blocks of the methods 100, 200 described herein. In some examples, the machine-readable medium 504 comprises instructions (e.g. data obtaining instructions 506) which, when executed by a processor 502, cause the processor to obtain data identifying a component of a print apparatus, the component to be used in a print operation to print a first region of a target image. in some examples, the machine-readable medium 504 comprises instructions (e.g. first parameter determining instructions 508) which, when executed by a processor 502, cause the processor to determine, based on the identity of the component, a first set of half-toning parameters to be used in generating a half-tone representation of the first region of the target image. In some examples, the machine-readable medium 504 comprises instructions (e.g. second parameter determining instructions 510) which, when executed by a processor 502, cause the processor to determine a second set of half-toning parameters to be used in generating a half-tone representation of a second region of the target image. Thus, the first set of parameters may be determined based on the identity of the print component and second set of parameters may be determined in some other way, for example not based on the identity of the print component, and/or based on other (e.g. standard) half-toning techniques.

In some examples, the machine-readable medium 504 may comprise instructions (e.g, print simulation application instructions) which, when executed by a processor 502, cause the processor to apply a printing simulation model to simulate a printing operation using the component of the print apparatus. The first set of half-toning parameters may be determined based an output of the printing simulation model.

Thus, examples disclosed herein enable a printing operation to be performed that is intended to mitigate or remove print quality defects resulting from print components in a print apparatus. Using processing techniques to vary half-toning parameters at various positions in a half-tone representation of a target image to be printed, the severity of defects that might otherwise occur can be reduced, such that the overall print quality is improved.

Examples in the present disclosure can be provided as methods, systems or machine readable instructions, such as any combination of software, hardware, firmware or the like. Such machine readable instructions may be included on a computer readable storage medium (including but is not limited to disc storage, CD-ROM, optical storage, etc.) having computer readable program codes therein or thereon.

The present disclosure is descried with reference to flow charts and/or block diagrams of the method, devices and systems according to examples of the present disclosure, Although the flow diagrams described above show a specific order of execution, the order of execution may differ from that which is depicted, Blocks described in relation to one flow chart may be combined with those of another flow chart. it shall be understood that each flow and/or block in the flow charts and/or block diagrams, as well as combinations of the flows and/or diagrams in the flow charts and/or block diagrams can be realized by machine readable instructions.

The machine readable instructions may, for example, be executed by a general purpose computer, a special purpose computer, an embedded processor or processors of other programmable data processing devices to realize the functions described in the description and diagrams. In, particular, a processor or processing apparatus may execute the machine readable instructions. Thus functional modules of the apparatus and devices may be implemented by a processor executing machine readable instructions stored in a memory, or a processor operating in accordance with instructions embedded in logic circuitry. The term ‘processor’ is to be interpreted broadly to include a CPU, processing unit, ASIC, logic unit, or programmable gate array etc. The methods and functional modules may all be performed by a single processor or divided amongst several processors.

Such machine readable instructions may also be stored in a computer readable storage that can guide the computer or other programmable data processing; devices to operate in a specific mode,

Such machine readable instructions may also be loaded onto a computer or other programmable data processing devices, so that the computer or other programmable data processing devices perform a series of operations to produce computer-implemented processing, thus the instructions executed on the computer or other programmable devices realize functions specified by flow(s) in the flow charts and/or block(s) in the block diagrams.

Further, the teachings herein may be implemented in the form of a computer software product, the computer software product being stored in a storage medium and comprising a plurality of instructions for making a computer device implement the methods recited in the examples of the present disclosure.

While the method, apparatus and related aspects have been described with reference to certain examples, various modifications, changes, omissions, and substitutions can be made without departing from the spirit of the present disclosure It is intended, therefore, that the method, apparatus and related aspects be limited only by the scope of the following claims and their equivalents. It should be noted that the above-mentioned examples illustrate rather than limit what is, described herein, and that those skilled in the art will be able to design many alternative implementations without departing from the scope of the appended claims, Features described in relation to one example may be combined with features of another example,

The word “comprising” does not exclude the presence of elements other than those listed in a claim, “a” or “an” does not exclude a plurality, and a single processor or other unit may fulfil the functions of several units recited in the claims,

The features of any dependent claim may be combined with the features of any of the independent claims or other dependent claims.

1. An image processing method comprising:
receiving information relating to a print component o be used to print a target image;
determining, based on the received information relating to the print component, half-toning parameters to be applied when generating a half-tone representation of the target image; and
generating, using the determined half-toning parameters, a half-tone representation of the target image.

2. A method according to claim 1, wherein different half-toning parameters are used for generating different regions of the half-tone representation.

3. A method according to claim 1, further comprising:
determining a region of the target image that is to be printed using the print component;
wherein determining half-toning parameters to be applied comprises determining half-toning parameters to be applied in the determined region of the target image.

4. A method according to claim 1, further comprising:
performing a printing simulation to simulate a printing operation to print the target image;
wherein receiving information comprises obtaining information based on the printing simulation.

5. A method according to claim 4, wherein performing the printing simulation comprises executing a computer-implemented printing model.

6. A method according to claim 1, wherein determining the half-toning parameters comprises applying a half-toning technique selected from a group comprising search-based half-toning; matrix half-toning; and error diffusion.

7. A method according to claim 1, wherein determining the half-toning parameters comprises determining a first set of half-toning parameters in respect of a first region of the half-tone representation and determining a second set of half-toning parameters in respect of a second region of the half-tone representation.

8. A method according to claim 1, further comprising:
performing a printing operation to print the target image based on the generated half-tone representation.

9. A method according to claim 1, further comprising:
storing the determined half-toning parameters in a storage medium to be used in generating a subsequent half-tone representation.

10. An apparatus comprising:
an information acquisition module to:
obtain information relating to a print component to be used to print an image; and
an image processing module to:
generate a half-tone representation of the image using a set parameters selected based on the obtained information.

11. An apparatus according to claim 10, wherein the image processing module is to:
determine a region of the image to be printed using the print component;
generate a first portion of the half-tone representation of the image using a first set of parameters based on the obtained information; and
generate a second portion of the half-tone representation of the image using a second set of parameters.

12. An apparatus according to claim 10, further comprising:
a simulation module to:
execute a computer-implemented model of a printing operation to print the image using the print component;
wherein the information acquisition module is to obtain the information relating to the print component based on an output of the computer-implemented model.

13. A apparatus according to claim 10, further comprising:
a memory, accessible by the information acquisition module, to store information relating to the print component.

14. A machine-readable medium comprising instructions which, when executed by a processor, cause the processor to:
obtain data identifying a component of a print apparatus, the component to be used in a print operation to print a first region of a target image;
determine, based on the identity of the component, a first set of half-toning parameters to be used in generating a half-tone representation of the first region of the target image; and
determine a second set of half-toning parameters to be used ire generating a half-tone representation of a second region of the target image.

15. A machine-readable medium according to claim 14, comprising instructions which,
when executed by a processor, cause the processor to:
apply a printing simulation model to simulate a printing operation using the component of the print apparatus;
wherein the first set of half-toning parameters is to be determined based an output of the printing simulation model.
